(19) United States
(12) Patent Application Publication
(10) Pub. No.: US 2005/0188803 A1
(43) Pub. Date: Sep. 1, 2005

(54) Crosscutter device for printed flat webs

(76) Inventor: Bernhard Ehret, Freiburg (DE)

Correspondence Address: DARBY & DARBY P.C., P. O. BOX 5257, NEW YORK, NY, 10150-5257, US

(21) Appl. No.: 11/068,656

(22) Filed: Feb. 23, 2005

(30) Foreign Application Priority Data
Mar. 1, 2004 (DE) 20 2004 003 304.6

(51) Int. Cl. B26D 1/56; B23D 25/02; B26D 5/08

(52) U.S. Cl. 83/329; 83/335; 83/342

(57) ABSTRACT

A crosscutter device (10) for producing portions from printing formats following one another endlessly in the transport direction (18) of a printed flat web (16) has two cutting units (12, 14) for the flat web (16), spaced apart from each other in the transport direction (18). Each cutting unit (12, 14) has a stationary knife (24, 34) and a knife (22, 32) rotating on a circular path. Each rotatable knife (22, 32) is assigned a separate motor drive (26, 36) effecting the respective rotation. For each motor drive (26, 36) there is a dedicated controller, in which reference rotational positions can be stored.

### TECHNICAL FIELD

The invention relates to a crosscutter device for producing portions from printing formats following one another endlessly in the transport direction of a printed flat web.

With the aid of such a device, continuous webs which are already printed are cut into single sheets of a desired format.

### PRIOR ART

In a known crosscutter device, two knives are fixed to a rotating cylinder and interact with a stationary knife in a rotational shearing cut. The two knives are at a circumferentially fixed distance from each other. This fixed distance determines the web length of the portion to be produced from the flat web. In order to be able to vary the portion length, the knife spacing on the cylinder must be changed or it is necessary for a new set of knives to be installed.

Furthermore, a crosscutter device having two rotatably driveable crosscutter cylinders is known. Fixed to each of these two crosscutter cylinders is a knife which interacts with a stationary knife, again in a rotational shearing cut. The two crosscutter cylinders are arranged above the flat web. The crosscutter cylinders are driven jointly by a single motor. The overall size of each of the two crosscutter cylinders determines the mutual minimum spacing of these two crosscutter cylinders. This minimum spacing results in the length of the portions to be cut out of a flat web with these two crosscutter cylinders not being able to fall below a specific minimum. Apart from this, the portion length can be changed appropriately by changing the mutual rotational position of the two knives on the two crosscutter cylinders. The changeover time required for such a change in the length of the portion is considerable, because of the requisite manual effort. In addition, the requisite manual adjustment activities assume not inconsiderable technical and manual capabilities of the respective operating personnel.

### SUMMARY OF THE INVENTION

Starting from this aforementioned prior art, the invention is based on the object of specifying a crosscutter device of the type mentioned at the beginning which may be operated as optimally as possible both from a technical and from an economic point of view.

This invention is provided by the features of the equivalent claims 1 and 2. Expedient developments of the invention form the subject of following subclaims.

A first configuration according to the invention of a crosscutter device according to the invention includes the fact that each of the two rotatably driven knives is assigned a separate motor drive effecting the respective rotation of each knife, and that, moreover, there is a dedicated controller for each motor drive, in which reference rotational positions can be stored. This makes it possible for the setting of the rotatably driven knives, generally fixed to correspondingly rotatably driven cylinders, once found for a specific portion in an intensive working process by a tool-setter, to be retrieved again simply at any desired times and set automatically. The reproducibility of such format settings once defined is consequently possible without difficulty even for untrained personnel.

The second configuration of the crosscutter device according to the invention includes the fact that one of the two cutting units having the one rotationally driveable knife is arranged on one side and the other of the two cutting units is arranged on the opposite, other side of the flat web in each case. This alternate arrangement of the two cutting units in relation to the flat web also permits format portions with a very small format length, since the minimum format length is no longer determined by the relatively large mutual spacing between the two crosscutter cylinders arranged on a flat web. In this case, a separate motor can likewise be provided to each of the two cutting units and, furthermore, again a controller can be assigned to each of these two motor drives, in which again desired reference rotational positions can be stored. This additional formation then has the additional advantage that any desired format sections, even small ones, can be set reproducibly in a straightforward manner.

Further advantages and features of the invention can be gathered from the features further specified in the claims and also the following exemplary embodiment.

### BREIF DESCRIPTION OF THE DRAWING

The invention will be described and explained in more detail in the following text by using the exemplary embodiment illustrated in the drawing:

FIG. 1 shows a flat web having a cutting unit according to the invention positioned above and below said web and which in each case can be driven separately,

FIG. 2 shows a position of the flat web as it is being cut up by the front, upper cutting unit,

FIG. 3 shows a position of the flat web according to FIG. 2 during its subsequent cutting up by the rear, lower cutting unit,

FIG. 4 shows an illustration enlarged by comparison with FIG. 1.

### WAYS OF IMPLEMENTING THE INVENTION

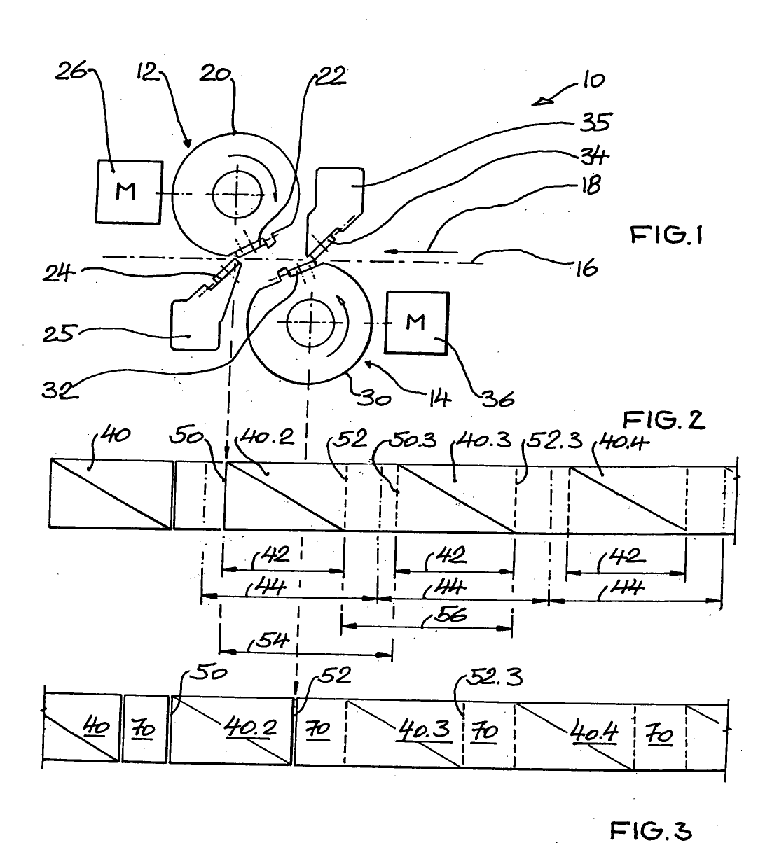

A crosscutter device 10 has two cutting units 12, 14, of which one cutting unit 12 is positioned above and the other cutting unit 14 is positioned below a flat web 16 indicated by a dash-dotted line. The flat web 16 in the present example is a printed paper web, which is led through the crosscutter device 10 in the transport direction 18 by conventional conveyor belts or roller conveyors not illustrated in FIG. 1.

The upper cutting unit has a crosscutter cylinder 20 with a knife 22 fixed thereto. This knife 22 cuts up the web 16 in interaction with a stationary knife 24 arranged underneath the web 16, in what is known as a rotational cut. The knife 24 is fixed in a stationary knife holder 25.

The crosscutter cylinder 20 has a dedicated motor drive 26. Any desired rotational positions of the crosscutter cylinder 20 can be stored in a controller, not illustrated in the drawing, for the motor 26. As a result, appropriate rotational positions of the crosscutter cylinder 20 can be retrieved without difficulty and set up again.

The lower cutting unit 14 is constructed in the same way as the upper cutting unit 12. A knife 32 is also fixed to its cylinder 30 and interacts with a stationary knife 34 arranged above the flat web 16 and fixed in a knife holder 35 in order to produce a rotational cut. The crosscutter cylinder 30 is driven by a separate motor drive 36. This motor drive 36 has a controller, in which reference positions of the crosscutter cylinder 30 can be stored.

The mutual rotational position of the two cylinders 20, 30 of the two cutting units 12, 14, once set, can be retrieved again reproducibly on the basis of the stored rotational positions in the two controllers of the two motor drives 26, 36. This means that the rotational position of the two cylinders 20, 30 and therefore that of their knives 22, 32 which is required for a specific cutting task can easily be set again.

The two cutting units 12, 14 act on the material web 16 in order to cut out portions 40, for example in a manner which is illustrated by way of example in FIGS. 2 and 3. Identical portions 40, 40.2, 40.3, 40.4 are to be cut out of the flat web 16 (FIG. 2). All these portions have the length 42 and are shorter than the corresponding gross format of the length 44 already printed on the web 16. The gross formats can be attached to one another continuously, leaving a space, but can also abut one another seamlessly, as in the present example.

As soon as the flat web 16 has arrived with its front line 50 of the portion 40.2 to be cut out, for example, in the region of the upper cutting unit 12, this line 50 is cut by the knives 22, 24 in a rotational cut (FIG. 2). After the rear line 52 of this portion 40.2 has subsequently arrived in the region of the lower cutting unit 14, the web 16 is likewise cut through in a rotational cut along the line 52 by the knives 32, 34 of said unit. In this way, the portion 40.2 is separated out from the web 14. The procedure is then carried out similarly with the following portions 40.3, 40.4. As soon as the respective front line 50.3 of the portion 40.3 to be produced has reached the front cutting unit 12, the appropriate crosscut is produced on the line 50.3. A corresponding cut is then likewise produced on the rear line 52.3 of the portion 40.3 by the lower cutting unit 14. In this way, the individual portions are subsequently separated from the web 16.

Since the distance 54 between the respective front boundary line 50, 50.3 of successive portions 40.2, 40.3 is of exactly the same size as the mutual spacing 56 of the rear boundary lines of 52, 52.3 of these successive two portions 40.2, 40.3, the two cylinders 20, 30 can be driven synchronously. In the present case, the motors 26, 36 are servo motors which each have a dedicated register controller. The respective rotational position of the two cylinders in relation to the individual portions 40 to be produced is stored in this register controller. As a result, portion-related data can be deposited and therefore easily retrieved again when the two crosscut cylinders 20, 30 need to set again anew in accordance with the respectively desired portions.

The flat web 16 in the region between the two stationary knives 24, 34 rests on a transport belt 60 circulating continuously around three deflection rolls in the present example. In the region between its two upper deflection rolls 61, 63, this transport belt 60 is driven by a drive motor, not illustrated, in the transport direction 18 and therefore in the same way as the flat web 16. Therefore, with the flat web transported through the crosscutter device 10 in the transport direction 18, after it has already been severed in the transverse direction by the lower cutting unit 14, for example along the rear line 52, the web section 70 between this line 52 and the line 50.3 located behind it is pushed in the direction of the first cutting unit 12 by the regions of the flat web present behind this web section. By means of the conveyor belt 60, this web section 70 can be moved actively in the transport direction 18. This active movement is possible for all the web regions in the region between the two cutting units 14 and 12.

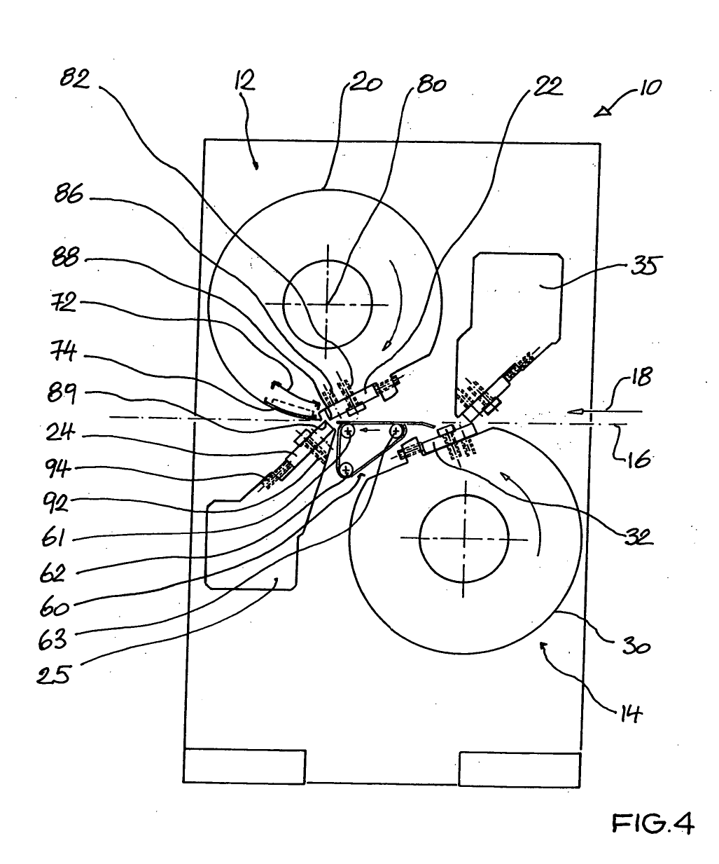

The web sections 70 which are present between the portions 40.2, 40.3, 40.4 and are identical in the present example are cut completely out of the flat web 16 after passing the first cutting unit 12. In the crosscutter cylinder 20 of the upper cutting unit 12, the circumference of the crosscutter cylinder 20 is perforated or provided with holes in a circumferential region 72 adjoining its knife 22. circumferentially. This perforation represents suction holes which, at the end of their holes pointing into the interior of the cylinder 20, are connected to a vacuum source, not illustrated in the drawing. After a cut has been produced in the region of the upper cutting unit 12, which is illustrated in FIG. 4, for example, a relevant web section 70 is cut completely out of the flat web 16. This section is then sucked onto the cylinder 20 through the perforated circumferential surface 74, is raised obliquely upward out of the region of the flat web 16 in the direction of rotation 76 during further rotation of the cylinder 20 and is subsequently blown away from the cylinder 20. The action of blowing away is effected by an appropriate positive air pressure in the region of the perforated surface 72. Air for sucking on a web section 70 is taken in through the perforated surface 72, specifically over a specific time period, and then air is expelled through this perforated surface region again in order to move the web section 70 away from the surface of the cylinder 20 again. Following a complete revolution of the cylinder 20 through 360°, a new web section. 70 can again be sucked on from the region of the flat web 16. From the cylinder 20, the web sections 70 can be put into a waste container.

The knife 22, and this is correspondingly true of the knife 32 fixed to the lower cutting unit 14, is kept firmly screwed to the cylinder 20 by a plurality of screws 82 arranged distributed along the axis of rotation 80. In addition, the knife 22 is forced in the direction of the stationary, lower knife 24 by means of set screws 84. Finally, the cutting edge 88 of the knife 22 can be moved away from the cylinder 20 in the direction parallel to the operative axis of the fixing screws 82 by means of further set screws 86. As a result, the cutting edge. 88 of the knife 22 can be aligned accurately with the cutting edge 89 of the lower knife 24 and also kept in this alignment. The lower knife 24 is also fixed in the same way as the knife 22. Thus, there are fixing screws 92 which hold the knife 24 firmly on the knife holder 25. Furthermore, screws 94 comparable with the set screws 84 are present. Finally, screws 96 comparable with the screws 86 are also present and are merely illustrated by their screw axis in FIG. 4. A comparable fixing also applies to the knives 32, 34 of the lower cutting unit 14. The cutting unit 14 is constructed identically to the cutting unit 12 apart from the difference that no regions of the flat web 16 have to be sucked onto its crosscutter cylinder 30 and blown away and therefore it has no perforated surface 72.

The cutting unit 12—a comparable statement also applies to the cutting unit 14—can be pivoted in a plane which is parallel to the flat web 16. In this case, the axis of rotation 80 remains in its alignment parallel to the flat web 16. Different pivoting positions achieve the situation where, depending on the respective transport speed of the flat web 16, cutting lines 50, 52 can always be produced accurately at right angles to the transport direction 18. This type of adjustment is known per se in rotary cutting.

As distinct from the exemplary embodiment, the two cutting units 12, 14 could also be arranged to be interchanged in the transport direction 18. Thus, in relation to FIG. 4, the right-hand cylinder 30 could be above the flat web 16 and the left-hand cylinder 20 could be below the flat web 16.

1. A crosscutter device (10) for producing portions from printing formats following one another endlessly in the transport direction (18) of a printed flat web (16),
having two cutting units (12, 14) for the flat web (16), spaced apart from each other in the transport direction (18),
having a stationary knife (24, 34) and a knife (22, 32) rotating on a circular path, belonging to each cutting unit (12, 14),
wherein
each rotatable knife (22, 32) is assigned a separate motor drive (26, 36) effecting the respective rotation,
for each motor drive (26, 36) there is a dedicated controller, in which reference rotational positions can be stored.

2. A crosscutter device (10) for producing portions from printing formats following one another endlessly in the transport direction (18) of a printed flat web (16),
having two cutting units (12, 14) for the flat web (16), spaced apart from each other in the transport direction (18),
having a stationary knife (24, 34) and a knife (22, 32) rotating on a circular path, belonging to each cutting unit (12, 14),
wherein
the one cutting unit (12) is present on one side of the flat web (16) and the other cutting unit (14) is present on the opposite, other side of the flat web (16).

3. The crosscutter device as claimed in claim 2,
wherein
each rotatable knife (22, 32) is assigned a separate motor drive (26, 36) effecting the respective rotation,
for each motor drive (26, 36) there is a dedicated controller, in which reference rotational positions can be stored.
